(19) United States
(12) Patent Application Publication
(10) Pub. No.: US 2022/0225476 A1
(43) Pub. Date: Jul. 14, 2022

(54) Improved Induction Cooking System

(71) Applicant: FABITA S.R.L., Serra San Quirico (IT)

(72) Inventors: Davide Adriano, Torino (IT); Gabriele Adriano, Torino (IT)

(21) Appl. No.: 17/607,205

(22) PCT Filed: Mar. 30, 2020
(86) PCT No.: PCT/IT2020/050081

§ 371 Date: Oct. 28, 2021

(30) Foreign Application Priority Data
May 2, 2019 (IT) 102019000006484

(51) Int. Cl. H05B 6/12; F24C 15/10

(52) U.S. Cl. CPC H05B 6/1272; F24C 15/103

(57) ABSTRACT

An induction cooking system is described, including: a mobile induction cooking plate; a remote control and power system operatively connected to an induction cooking plate through a respective connection; and a housing device equipped with one or more seats, the induction cooking plates being designed to be accommodated in respective seats; the connection composed of a flexible transmission cable designed so that the related induction cooking plate is adapted to be arranged on a working plane in the most suitable and comfortable position for a user.

### BACKGROUND

The present disclosure refers to an improved induction cooking system.

A wide number of induction cookers are known, of the so-called “freestanding” type, namely of the type composed of a single structure incorporating one or more induction cooking plates and their related electric and electronic operation control systems, with their electric supply systems either from mains and with a battery.

However, given their specific arrangement, such known cookers are relatively cumbersome on the shelves or on the working planes, above all in a kitchen (therefore, sometimes, they are designed to be hanged to a wall, though being, also in such situation, heavy and scarcely manageable) and are scarcely suitable to the use flexibility required by different cooking situations (for example, when the cooking containers have big sizes, thing that frequently generates the overlapping of the container itself to many cooking planes, necessarily adjacent, since they are arranged in a fixed position on the same cooker).

Moreover, given the presence on board of their own electric and electronic control and supply systems, such known cookers cannot be obviously subjected to be washed with running water, such as, for example, in a dishwashing machine.

Moreover, in traditional induction cooking planes (namely those which appear as black rectangles with inductors below, designed for a positioning, but not for an actual occupation area) often, without knowing it, the size of the inducer is bigger than the size of the pot which is housed above, and this implies a waste of power and an increase of the electromagnetic pollution due to leakages/dispersions in the electromagnetic field.

Documents WO-A1-2018/153505, JP-A-H06 215858, EP-A1-2558785, US-A1-2017/318628, DE-A1-10 2015 203316 and EP-A1-2790467 disclose induction cooking systems.

### SUMMARY

Therefore, the disclosed embodiments solve the above prior art problems, by providing an improved induction cooking system which allows a greater flexibility of use with respect to prior art cookers.

The disclosed embodiments also provide an improved induction cooking system which allows easily exploiting different cooking planes even when using big-sized cooking containers.

Moreover, the disclosed embodiments provide an improved induction cooking system which allows reducing and/or optimizing the spaces occupied on the working plane with respect to prior art working stations.

The disclosed embodiments provide an improved induction cooking system which allows easily disconnecting the mobile induction plates from their own electric and electronic control and supply systems, in order to be easily wash them, even, for example, in a dishwashing machine,

Moreover, the disclosed embodiments provide an improved induction cooking system which allows accurately pointing out the size of the inductor housed below a specific induction cooking plate, depending on the diameter of this latter one with respect to other plates of the system itself, informing thereby a user about the most suitable choice for the pot which is being used.

The above and other advantages of the disclosed embodiments, as will appear from the following description, are reached with an induction cooking system as disclosed.

Preferred embodiments and non-trivial variations of the present disclosure are the subject matter of the disclosed embodiments.

It is intended that all enclosed claims are an integral part of the present description.

It will be immediately obvious that numerous variations and modifications (for example related to shape, sizes, arrangements and parts with equivalent functionality) can be made to what is described, without departing from the scope of the disclosure.

### BRIEF DESCRIPTION OF THE DRAWINGS

FIG. 1 is a perspective view of an induction cooking system incorporating features of the disclosure;

FIG. 2 is another perspective view of the system shown in FIG. 1;

FIG. 3 is another perspective view of the system shown in FIG. 1;

FIG. 4 is another perspective view of the system shown in FIG. 1;

FIG. 5 is another perspective view of the system shown in FIG. 1; and

FIG. 6 is another perspective view of the system shown in FIG. 1.

### DETAILED DESCRIPTION

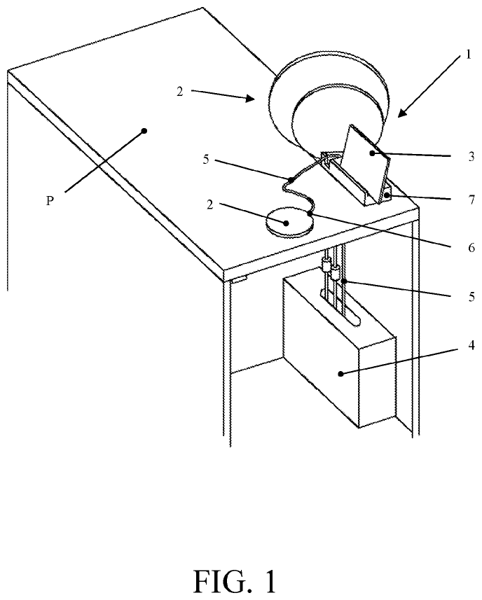

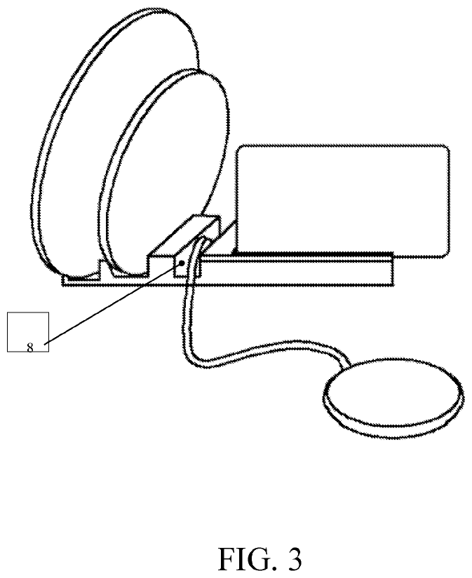

The disclosure will be better described by some preferred embodiments thereof, provided as a non-limiting example, with reference to the enclosed drawings, in which FIGS. 1 to 6 show perspective views of a preferred embodiment of the induction cooking system according to the disclosed embodiments under various operating positions.

Therefore, with reference to the Figures, it is possible to note that the induction cooking system 1 according to the present disclosure comprises:
at least one mobile induction cooking plate 2;
at least one remote control and power system 4 operatively connected to at least one of such induction cooking plates 2 through at least one respective connection means 5 for the transmission of operating electric energy and of operating control and command signals to at least one of such induction cooking plates 2, for example by withdrawing electric supply power from an electric supply mains, and providing operating control signals to determine the operating conditions.

Obviously, the number of plates 2 of the system 1 according to the present disclosure, as well as their diameter and their delivered power, can be various, without thereby departing from the scope of the disclosed embodiments,

It is further possible to provide that the size of the inductor housed below a specific induction cooking plate 2 of the system 1 according to the present disclosure depends on the diameter of the plate 2 itself.

Preferably, the system 1 according to the present disclosure can comprise at least one control device 3 (such as, for example, a tablet or keyboard of the “touch screen” type) operatively connected at least to the remote control and power system 4.

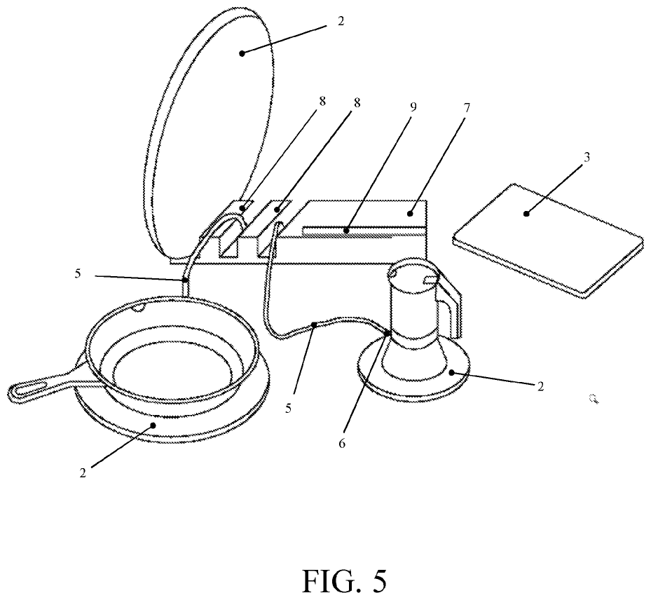

Preferably, such control device 3 is connected to the remote control and power system 4 through a wireless connection. In such case, as it is possible to note in FIG. 5, the control device 3 can advantageously be used also remotely,

In particular, such remoted control and power system 4 can be equipped with processing means programmed to drive and manage the induction operation of at least one induction cooking plate 2 through the respective connection means 5.

The connection means 5 can therefore be aimed to the transmission both of operating electric energy and of operating control signals for the operation of the induction cooking plate 2 from the remoted control and power system 4 to determine its operating conditions.

The connection means 5 can preferably be at least one flexible electric transmission cable of an adequate length.

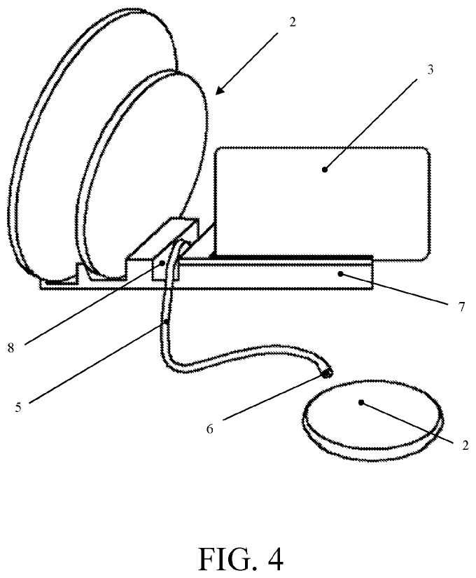

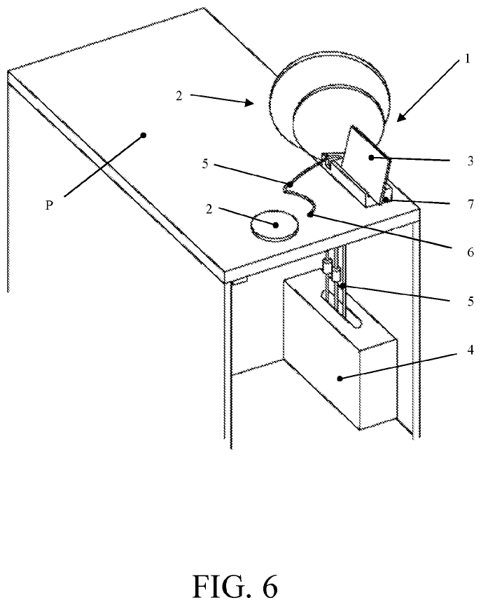

Advantageously, as it is possible to note in FIGS. 4 and 6, the connection means 5 can be equipped with a connection interface 6 (for example of the pin, jack, USB type, etc.) which allows its quick and easy connection/disconnection with respect to the related plate 2, as it is possible to note, for example, in FIGS. 4 and 6.

In a preferred embodiment of the system 1 according to the present disclosure, the remote control and power system 4 is aimed to be placed below a working plane P such as, for example, the “top” plane of a kitchen.

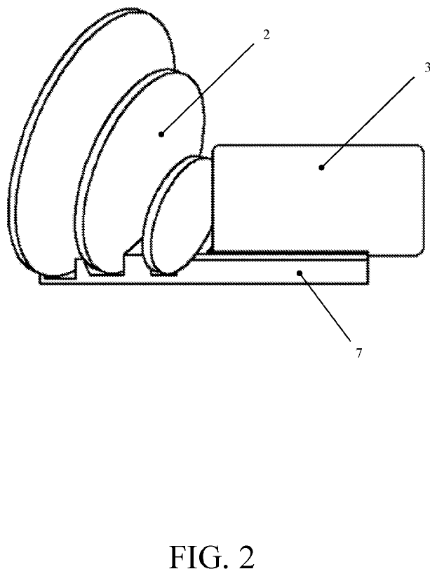

As it is possible to note in FIGS. 2, 3 and 5, the system 1 according to the present disclosure can comprise at least one housing device 7, for example of the rack type, equipped with one or more seats 8 (as shown, for example, in FIG. 2) and the induction cooking plates 2 can be, if not used, suitably accommodated in such respective seats 8 of the housing device 7, or, in case of need, be individually placed, in a varying number, on the working plane P to optimize space on the working plane P according to the user's needs.

The housing device 7 can also comprise at least one suitable seat 9 adapted to house the control device 3.

For example, it can be provide that the housing device 7 is connected to the working plane P (as shown in the Figures) or to a wall next to the working plane P through suitable fastening means, such as, for example, small blocks, nails, screws, glues, etc., or be simply rested onto the working plane P itself.

The induction cooking system 1 according to the disclosed embodiments as described above thereby allows obtaining its pre-fixed objects.

In fact, advantageously, remotely placing the control and power system 4 allows using very thin induction cooking plates 2, because they are free from any sensible electric component, which is therefore arranged in the related control and power system 4.

Moreover, the same control device 3 with its related control means can manage, even at a distance and under wireless mode, the operation of a varying number, even high, of induction plates 2.

Moreover, any induction cooking plate 2, once disconnected from its related connection means 5 due to the connection interface 6, can be washed in a dishwashing machine.

Moreover, due to a suitable flexibility and length of the transmission cable composing the connection means 5, the related induction cooking plate 2 can be arranged on the working plane P in the more suitable and comfortable position for a user.

Moreover, when there are many induction cooking plates 2, always due to the suitable flexibility and length of the transmission cables composing the related connection means 5, the same induction cooking plates 2 can be mutually arranged in the most adequate positions, allowing to make extremely versatile configurations.

Moreover, differently from prior art cooker assemblies comprising many fixed induction cooking planes, in which possible big-sized cooking containers (pots, pans, baking tins, cooking pans, etc.) could occupy many cooking planes, in a system 1 according to the present disclosure comprising many induction cooking plates 2, these latter ones can be suitably placed, consequently allowing the different use of only one of such induction cooking plates 2 also by a big-sized cooking container, without uselessly engaging the other possible induction plates 2 of the system 1.

Moreover, it is possible to choose the induction cooking plate 2 whose diameter and size are most suitable to the possible cooking container (pots, pans, baking tins, cooking pans, etc.) which it must house: for example, the diameters can have set a certain power and therefore, depending on the chosen diameter, there can be a different cooking temperature without having any control to be actuated.

1-6. (canceled)

7. An induction cooking system comprising:
a plurality of mobile induction cooking plates;
at least one remote control and power system operatively connected to the induction cooking plates through at least one respective connection;
wherein:
the system further comprises at least one housing device equipped with one or more seats, the induction cooking plates being designed to be accommodated in respective seats,
the connection is composed of a flexible transmission cable designed so that its related induction cooking plate is adapted to be arranged on a working plane in the most suitable and comfortable position for a user, the connection being designed for a transmission both of operating electric energy and of operating control signals for the operation of at least one of the induction cooking plates from the remote control and power system, and
the system further comprises at least one control device operatively connected at least to the remote control and power system.

8. The system of claim 7, wherein the control device is connected to the remote control and power system through a wireless connection.

9. The system of claim 7, wherein the connection is equipped with a connection interface for a connection/disconnection to the plate.

10. The system of claim 7, wherein the housing device comprises at least one seat adapted to house the control device.
